(19) United States
(12) Patent Application Publication
(10) Pub. No.: US 2011/0195193 A1
(43) Pub. Date: Aug. 11, 2011

(54) AN END SEALING DEVICE FOR A METERING NIP, A COATER WITH A SEALED END AND A METHOD OF USING SAME

(76) Inventor: Kurt W. Oster, Oakdale, MN (US)

(21) Appl. No.: 13/125,603

(22) PCT Filed: Oct. 23, 2009
(86) PCT No.: PCT/US09/61759

§ 371 Date: Apr. 22, 2011

Related U.S. Application Data
(60) Provisional application No. 61/107,936, filed on Oct. 23, 2008.

(51) Int. Cl. B05D 1/28; B05C 1/04; B05D 3/12; F16J 15/02

(52) U.S. Cl. 427/356; 118/200; 277/628

(57) ABSTRACT

A device (10) for sealing one or both ends of a metering nip. The device (10) comprises a high pressure chamber (12) and a low pressure chamber (14), with each chamber (12,14) comprising a sealing element (18,22) operatively adapted so as to form a seal with the metering nip. The low pressure chamber (14) is in contact with the fluid material metered by the metering nip. The high pressure chamber (12) is pressurized with a gas that will prevent substantially all of the fluid material from leaking out past the sealing element (18) of the high pressure chamber (12), and the low pressure chamber (14) is pressurized to a pressure that will not force a substantial amount of the pressurized gas into the fluid material to be metered.

The present invention relates to a device for sealing one or both ends of a metering nip, in particular, an end seal of a metering nip for forming a layer of fluid material, and more particularly, an end seal of a metering nip for vertically coating a layer from a liquid polymer material. The present invention also relates to a coater and a process that employs such a device.

### BACKGROUND

The ability to form coatings onto webs of indefinite length or to form stand alone films from a fluid material is a requirement frequently encountered in modern manufacturing. Numerous categories of coating and film forming techniques are known. The particular technique chosen can depend upon the type of material being used and the nature of the coating or film to be formed. One of these categories is roll coating. Roll coating can be a simple operation that employs, e.g., a coater comprised of only one roller that picks up a coating material from a coating pan and transfers it to a surface to be coated, or it can be more complex, e.g. employing multiple rollers that pick up, meter, and control the coating applied to the surface. One such complex coating configuration is known as a “five roll coater”.

Roll coaters are typically self-metering, with the fluid coating material being metered, e.g., either by a stationary contactor such as a Meyer rod or doctor blade, or a moving contactor such as a nip roller. Roll coaters that are self-metering have been used over a wide range of coating weights, line speeds and fluid coating material viscosities. Either end of the roll coater, where the fluid material is metered, is typically sealed to prevent loss of the fluid coating material. Various techniques and devices have been employed to perform this sealing function. U.S. Pat. No. 5,795,393, for example, discloses such a sealing device. Even though such techniques and devices exist, they can be less effective than desired in limiting the loss of the fluid coating material during the metering operation. Therefore, there is a need for a more effective sealing device and method.

### SUMMARY OF THE INVENTION

The present invention provides an inventive device and method of sealing one or both ends of a metering nip used to form a layer (e.g., a coating or separate film) from a fluid material, which more effectively prevents or at least reduces the leakage and loss of the fluid material during metering.

In one aspect of the present invention, a device is provided for sealing one or both ends of a metering nip for metering a fluid material, where the metering nip comprises a first metering surface opposite a second metering surface. The present sealing device comprises a high pressure chamber and a low pressure chamber. The high pressure chamber comprises a cavity operatively adapted (i.e., designed, dimensioned and/or formed) for being filled with a pressurized gas (e.g., air, nitrogen, etc.) and a sealing element (e.g., in the form of a plate, shim or gasket) that only partially or at least partially defines the high pressure cavity. The low pressure chamber comprises a cavity operatively adapted (i.e., designed, dimensioned and/or formed) for being filled with a pressurized gas (e.g., air, nitrogen, etc.) and another sealing element (e.g., in the form of a plate, shim or gasket) that only partially or at least partially defines the low pressure cavity. The sealing element of each of the pressure chambers has a first sealing surface and a second sealing surface. Each first sealing surface is resilient and operatively adapted (i.e., designed, dimensioned and/or formed), e.g., to match the curvature and/or topography of the first metering surface so as to be forced into contact and form a seal with the first metering surface of the metering nip. Each second sealing surface is resilient and operatively adapted (i.e., designed, dimensioned and/or formed), e.g., to match the curvature and/or topography of the second metering surface so as to be forced into contact and form a seal with the second metering surface of the metering nip. The low pressure chamber is disposed relative to the high pressure chamber such that the sealing element of the low pressure chamber will be in contact with the fluid material metered by the metering nip. The cavity of the high pressure chamber is operatively adapted (i.e., designed, dimensioned and/or formed) to be filled with a gas at a pressure that will prevent any or at least a substantial amount (i.e., a commercially significant amount) of the fluid material to be metered from leaking out past the sealing element of the high pressure chamber. The pressurized gas to be used in the low pressure chamber is to be at a pressure that will not force any or at least a substantial amount of the pressurized gas into the fluid material to be metered. As used herein, a substantial amount of pressurized air is an amount that causes an unacceptable number and size of gas bubbles to form in the fluid material being metered.

The following are a number of optional features that can be employed in practicing the present inventive sealing device. Each sealing element can comprise two separate and spaced apart resilient seals. Each pressure chamber can share one of the resilient seals. Each of the resilient seals can be, for example, in the form of a plate, shim or gasket. Each pressure chamber can comprise a rigid element, and each pressure chamber cavity can be only partially or at least partially defined by the rigid element. Each rigid element can be in the form of a plate such as, for example, a metal (e.g., aluminum) or rigid plastic plate, the device can comprise three sealing elements, each sealing element can be in the form of a plate such as, for example, a resilient plastic (e.g., Teflon) plate, preferably having first and second sealing surfaces that exhibit a low coefficient of friction, and each rigid element can be sandwiched between adjacent sealing elements. The device can further comprise two end plates, with the rigid elements and the sealing elements being sandwiched therebetween (e.g., a metal or rigid plastic plate). The present device can be wedge-shaped to match the metering nip formed between two metering rollers. The present sealing device can further comprise a separate source of pressurized gas for each of the pressure chambers. That is, the separate source of pressurized gas can be separate reservoirs of pressurized gas or a single source of pressurized gas that is separately regulated for each pressure chamber.

In another aspect of the present invention, a coater is provided for forming a layer of fluid material. The coater comprises a metering nip for vertically, horizontally or otherwise metering a fluid material into a layer (e.g., a coating or separate film). The metering nip comprises two ends, and a first metering surface opposite a second metering surface. The coater also comprises a sealing device according to the principles of the present invention. The sealing device is mounted so as to seal one end of the metering nip.

The following are a number of optional features that can be employed in practicing the present inventive coater. The coater can further comprise a separate source of pressurized gas for each pressure chamber (i.e., separate reservoirs of pressurized gas or a single source of pressurized gas that is separately regulated for each pressure chamber). The coater can also comprise another sealing device according to the present invention that is mounted so as to seal the other end of the metering nip. At least one or both of the metering surfaces can be a moving endless surface such as, for example, the surface of a nip roller or an endless loop belt. While using a moving endless surface for each metering surface can be preferred, it can also be desirable for one or both of the metering surfaces to be stationary (e.g., a notch bar, doctor blade, Meyer rod, etc.). Each metering surface can be a moving endless surface (e.g., an exterior surface of a nip roller, an endless loop belt, etc.). The metering surface can be a surface of a web (e.g., a liner, film, layer, etc.) of finite length moving through the metering nip, the coater can further comprise a moving endless surface or a stationary surface (e.g., a bar, rod, plate, etc.) backing the web, and the fluid material can be applied so as to form a coating on the web. The first metering surface and the second metering surface can be oriented such that the fluid material passes vertically through the metering nip.

In an additional aspect of the present invention, a method of coating or otherwise forming a layer of fluid material is provided. The method comprises providing a metering nip that includes a first metering surface opposite a second metering surface and opposite ends. The method also comprises sealing at least one opposite end of the metering nip with a sealing device according to the present invention so as to form a metering reservoir. The method further comprises disposing a fluid material within the metering reservoir; and vertically, horizontally or otherwise metering the fluid material into a layer (e.g., a coating or separate film).

The following are a number of optional features that can be employed in practicing the present inventive method. The sealing operation can comprise sealing each opposite end of the metering nip with a sealing device according to the present invention. The sealing operation can also comprise forcing each first sealing surface and each second sealing surface, of each sealing device, respectively against the first metering surface and the second metering surface so as to make contact therebetween and seal the corresponding end of the metering nip. The sealing operation can further comprise disposing the low pressure chamber relative to the high pressure chamber such that the sealing element of the low pressure chamber contacts the fluid material in the metering reservoir. The method according to the present invention can additionally comprise filling the cavity of the high pressure chamber with a gas at a first pressure; and filling the cavity of the low pressure chamber with a gas at a second pressure, wherein the first pressure prevents any or at least a substantial amount of the fluid material (i.e., a commercially significant amount of the fluid material) from leaking out past the sealing element of the high pressure chamber during the metering, and the second pressure does not force any or at least a substantial amount of the pressurized gas into the fluid material in the metering reservoir during the metering. It can be desirable for the gas pressure in the high pressure chamber to prevent a commercially significant amount of the fluid material from leaking out past the sealing element of the high pressure chamber and for the gas pressure in the low pressure chamber not to force an amount of the pressurized gas into the fluid material that would cause an unacceptable number and size of gas bubbles to form in the fluid material being metered. To accomplish this, it may be necessary for the first pressure to be higher than the second pressure.

Each of the metering surfaces can be a moving endless surface (e.g., the surface of a nip roller, an endless loop belt). The first metering surface can also be a moving endless surface, and the second metering surface can be a stationary surface (e.g., a notch bar, doctor blade, Meyer rod, etc.). Each such moving endless surface can be a radial surface of a nip roller. The present method can further comprises providing a web (e.g., a liner, film, layer, etc.) of finite length having a web surface that forms the first metering surface; and backing the web with a moving endless surface (e.g., the surface of a nip roller, an endless loop belt) or a stationary surface (e.g., a bar, etc.), wherein the layer is a coating, and the metering further comprises moving the web through the metering nip so that the web surface is coated with the fluid material to form the coating. The metering operation can further comprise orienting the first metering surface and the second metering surface so as to vertically meter the fluid material through the metering nip to form the layer.

While the present invention is described herein as employing a high and a low gas pressure for the two pressure chambers, it should be understood that it may be acceptable to use the same gas pressure for each pressure chamber, as long as the objectives are reached of (a) not forcing at least a substantial amount of the pressurized gas from the low pressure chamber into the fluid material to be metered and (b) preventing at least a substantial amount (i.e., a commercially significant amount) of the fluid material to be metered from leaking out past the sealing element of the high pressure chamber.

These and other advantages of the invention are more fully shown and described in the drawings and detailed description of this invention, where like reference numerals are used to represent similar parts. It is to be understood, however, that the drawings and description are for illustration purposes only and should not be read in a manner that would unduly limit the scope of this invention.

### BRIEF DESCRIPTION OF THE DRAWINGS

In the accompanying drawings:

FIG. 1 is a perspective view of a sealing device 10 in accordance with the present invention.

FIG. 2 is a end view of the device of FIG. 1.

FIG. 3 is a side view of the device of FIG. 1.

FIG. 4 is an end view of a coater 60 with the device of FIG. 1 disposed so as to seal between two opposing nip rollers.

FIG. 5 is a down web view of the coater of FIG. 4, with the rollers removed and the device of FIG. 1 disposed so as to be at either end of the metering nip.

FIG. 6 is an exploded perspective view of the device of FIG. 1.

FIG. 7 is a cross sectional end view through the central plane of the first rigid element of the device of FIG. 1.

FIG. 8 is a cross sectional end view through the central plane of the second rigid element of the device of FIG. 1.

### DETAILED DESCRIPTION OF EXEMPLARY EMBODIMENTS

In describing exemplary embodiments of the invention, specific terminology is used for the sake of clarity. The invention, however, is not intended to be limited to the specific terms so selected, and each term so selected includes all technical equivalents that operate similarly.

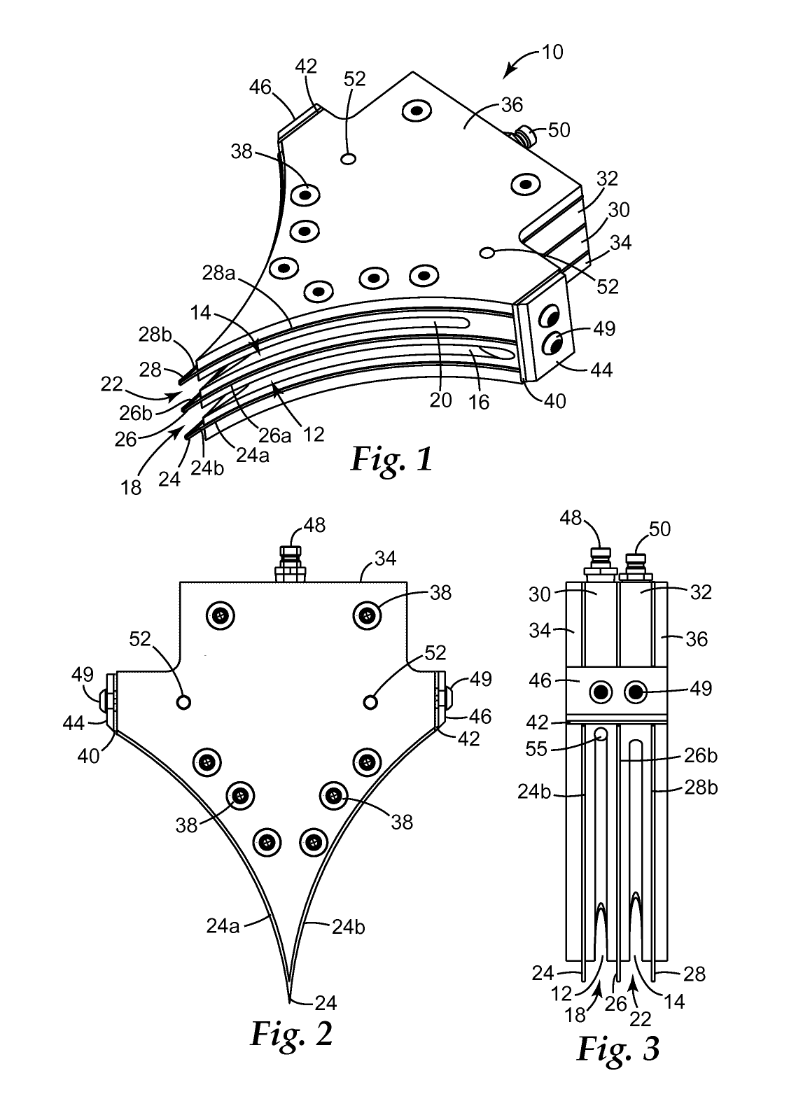

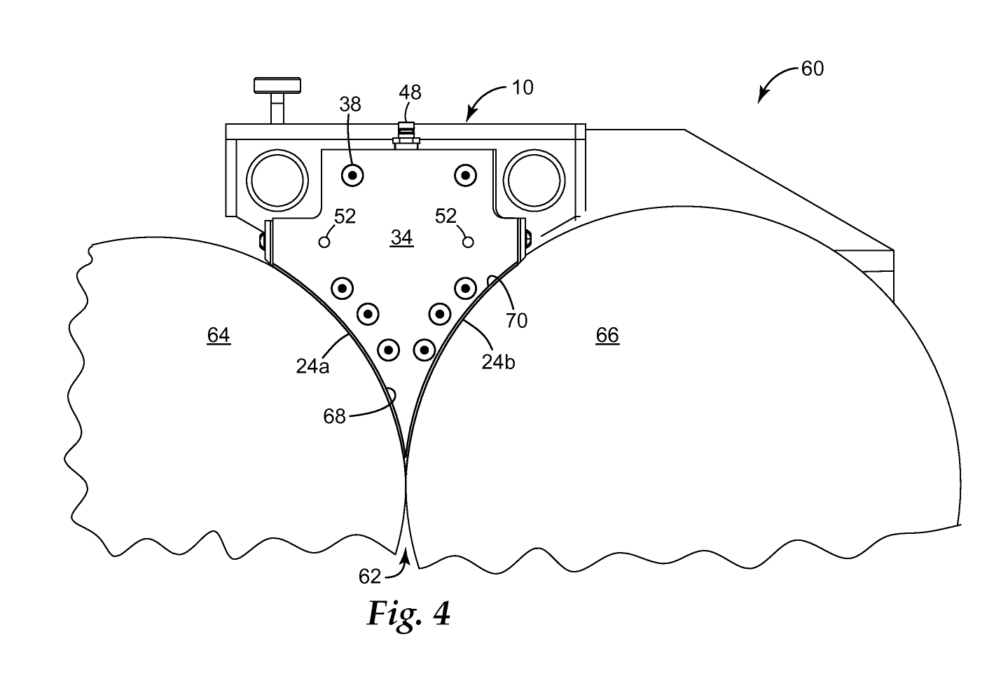

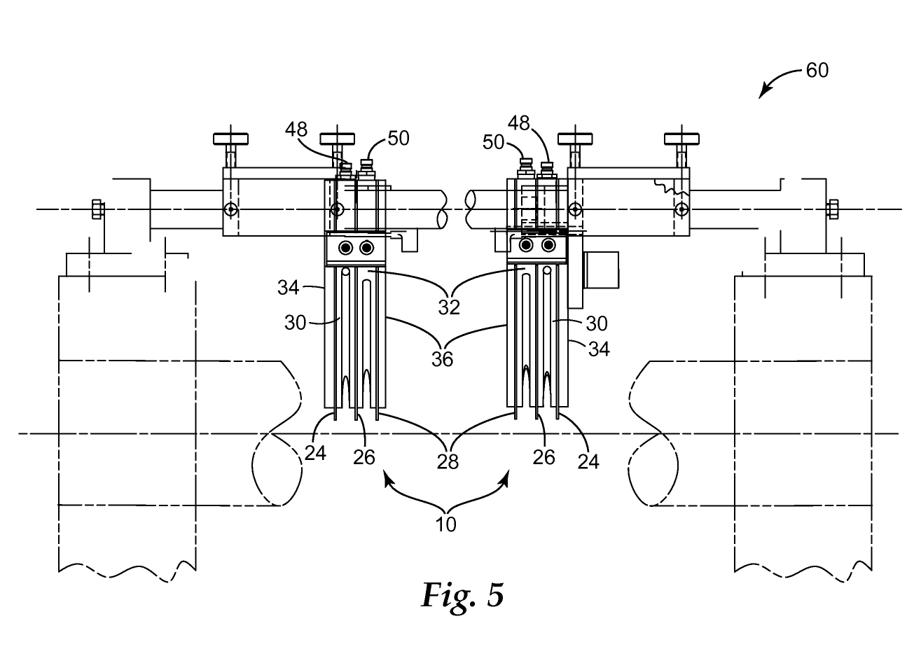

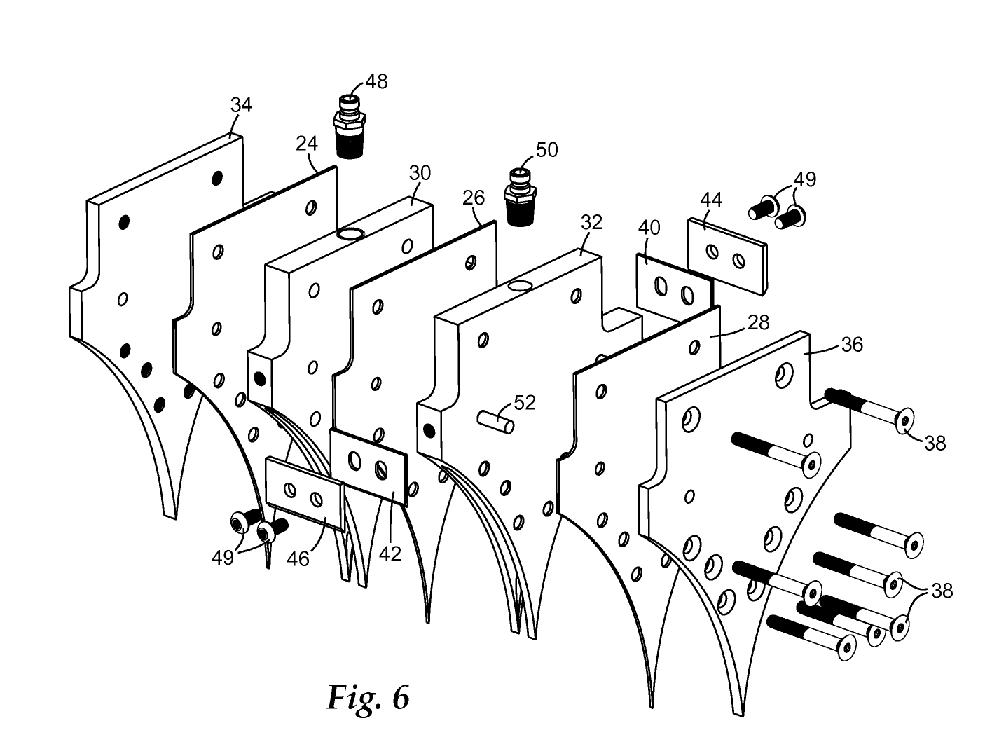

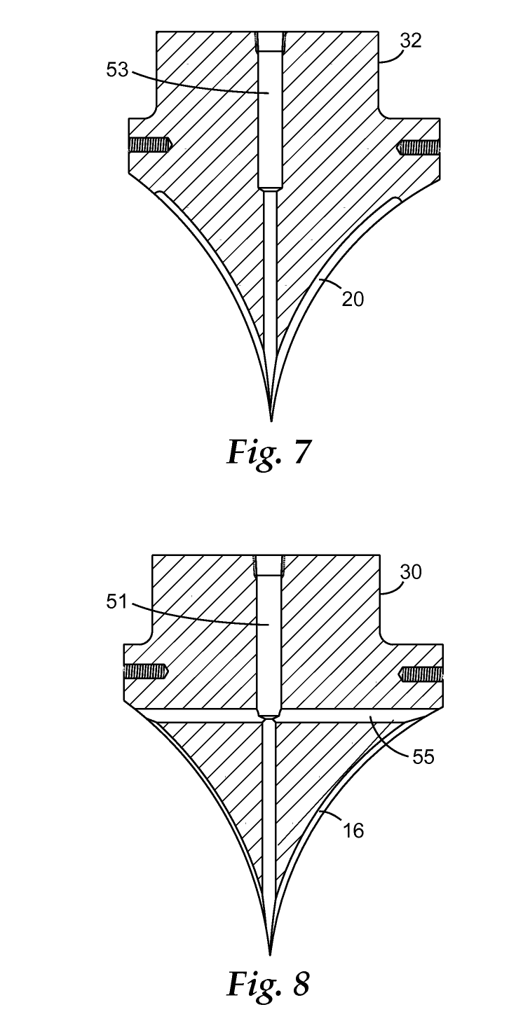

Referring to FIGS. 1-3, a sealing device 10 is used to seal an end of a metering nip for metering a fluid material (e.g., a liquid polymeric material). The illustrated embodiment is particularly shaped for sealing a metering nip formed by two adjacent rollers (e.g., see FIGS. 4 and 5, and the related description below) such as would be encountered, for example, in a five roll coater. The sealing device 10 includes a high pressure chamber 12 and a low pressure chamber 14. The high pressure chamber 12 comprises a cavity 16 operatively adapted for being filled with a pressurized gas, and a sealing element 18 that partially defines said high pressure cavity 16. The low pressure chamber 14 comprises a cavity 20 operatively adapted for being filled with a pressurized gas, and a sealing element 22 that partially defines the low pressure cavity 16.

In the particular depicted embodiment, sealing element 18 conveniently comprises two separate and spaced apart seals 24 and 26, and the sealing element 22 conveniently comprises two separate and spaced apart seals 26 and 28. This illustrates that, when convenient, it is within the scope of the invention for the high and the low pressure chambers 12 and 14 to share a seal (i.e., seal 26). The sealing element 18 has two first sealing surfaces 24a and 26a, defined respectively by an arcuate edge of the seals 24 and 26, and two second sealing surfaces 24b and 26b, defined respectively by an opposite arcuate edge of the seals 24 and 26. Likewise, the sealing element 22 has two first sealing surfaces 26a and 28a, defined respectively by an arcuate edge of the seals 26 and 28, and two second sealing surfaces 26b and 28b, defined respectively by an opposite arcuate edge of the seals 26 and 28. Each of these first sealing surfaces 24a, 24a, and 28a is resilient and operatively adapted so as to be forced into contact and form a seal with the arcuate outer surface of a nip roller such as, for example, that shown in FIGS. 4 and 5, and described below. Each of these second sealing surfaces 24b, 26b, and 28b is resilient and operatively adapted so as to be forced into contact and form a seal with the arcuate outer surface of an opposing nip roller such as, for example, that shown in FIGS. 4 and 5, and described below.

The depicted embodiment illustrates a particularly convenient way of constructing a sealing device 10 of the present invention. Seals 24, 26, and 28 are conveniently in the form of a wedge-shaped plate or shim. The cavities 12 and 14 are mostly defined by surfaces formed inside of first and second rigid elements 30 and 32, respectively. In the depicted embodiment, each of rigid elements 30 and 32 is in the form of a wedge-shaped plate or shim that has been slotted along its arcuate edges to form the cavities 12 and 14. The rigid plates 30 and 32 are disposed adjacent the sealing plates 24, 26 and 28, with the rigid plate 30 being sandwiched between sealing plates 24 and 26, and the rigid plate 32 being sandwiched between sealing plates 26 and 28. This assembly of plates 24/30/26/32/28 is also sandwiched between two rigid end plates 34 and 36. The resulting sandwich of plates 34/24/30/26/32/28/36 can be held together using fasteners such as, e.g., bolts 38. One or more dowel pins 52 may optionally be present to help keep the several parts of device 10 in alignment during assembly.

The seals 24, 26, and 28 can be constructed of diverse materials; however it is required that the sealing materials used by substantially resistant to chemical degradation caused by interaction with the fluid coating material to be metered. In embodiments such as the one illustrated in FIGS. 1-3, where moving contact with metering rolls is contemplated, good wear resistance and/or low friction with the surface of the metering rolls is considered desirable. Materials such as polytetrafluoroethylene (Teflon™) or polyoxymethylene (Delrin™) can be suitable. Each of the rigid elements 30 and 32, and end plates 34 and 36, can be made of a rigid and strong material such as, e.g., a metal or metal alloy (e.g., aluminum, aluminum alloy, stainless steel or the like), that is likewise resistant to chemical degradation caused by interaction with the fluid coating material.

In the illustrated embodiment, because the sealing elements 18 and 22 are formed using individual and separate seal plates 24, 26, and 28, as opposed to being integrally joined together, cross-web seals 40 and 42 are provided to enclose the cavities 16 and 20, when the seals 24, 26, and 28 make sealing contact with corresponding metering rollers. Cross-web seals 40 and 42 can be plates constructed from the same sorts of materials as seals 24, 26, and 28. They can be held in place by, e.g., support plates 44 and 46 fastened to the rigid plates 30 and 32 using, e.g., bolts 49.

Each sealing device 10 includes two pressurized gas inlets 48 and 50 (e.g., quick release air pressure nipples) mounted so as to respectively connect to cavities 16 and 18 via internal passageways 51 and 53 as shown in phantom in FIG. 3. To help insure that the gas pressure in chamber 12 is uniform throughout, another passageway 55 is also formed transversely through the rigid plate 30 and the passageway 51, thereby providing pressurized gas to either end of each arcuate section of the cavity 16.

It can be desirable for a separate source of pressurized gas to be used for each of the pressure chambers 12 and 14. That is, the separate source of pressurized gas can be separate reservoirs of pressurized gas or a single source of pressurized gas that is separately regulated for each pressure chamber. Successful results have been obtained, when metering a liquid silicone coating material, operating the device 10 using a single source of air pressurized to approximately 80 psig (0.55 MPa) and then regulating the air pressure down before filling the cavities 16 and 18 of chambers 12 and 14. The air pressure used in chamber 12 is higher than the air pressure in chamber 14.

While the present invention is described herein as employing a high and a low gas pressure for the two pressure chambers, it should be understood that it may be acceptable to use the same gas pressure for each pressure chamber, as long as the objectives are reached of (a) not forcing at least a substantial amount of the pressurized gas from the low pressure chamber into the fluid material to be metered and (b) preventing at least a substantial amount (i.e., a commercially significant amount) of the fluid material to be metered from leaking out past the sealing element of the high pressure chamber.

Referring to FIGS. 4 and 5, a coater 60 according to the present invention can conveniently comprise two of the sealing devices 10, with each of the two sealing devices 10 being disposed so as to seal either end of a metering nip 62 used to meter a fluid material (e.g., a polymeric liquid) into a coating or a separate stand alone film. The metering nip 62 is formed by first and second adjacent nip rollers 64 and 66. The first adjacent roller 64 comprises a first metering surface 68, and the second adjacent roller 66 comprises a second metering surface 70 opposite the first metering surface 68.

In use, the low pressure chamber 14 is disposed relative to the high pressure chamber 14 such that the sealing element 20 of the low pressure chamber 14 will be in contact with the fluid material metered by the metering nip 62 (i.e., inboard of the ends of the nip rollers 64 and 66). The cavity of the high pressure chamber 14 is operatively adapted to be filled with a gas at a pressure that will prevent a substantial amount of the fluid material being metered by the low pressure chamber 14 from leaking out past the sealing element 18 of the high pressure chamber 12. The pressurized gas in the low pressure chamber 14 is set at a pressure that will not force a substantial amount of the pressurized gas into the fluid material being metered.

In this Figure it can be more readily appreciated that in this embodiment, the first sealing surfaces 24a, 26a and 28a and the second sealing surfaces 24a, 26a and 28b are cut to exactly match the circumference of the metering rollers.

This invention may take on various modifications and alterations without departing from its spirit and scope. Accordingly, this invention is not limited to the above-described but is to be controlled by the limitations set forth in the following claims and any equivalents thereof.

This invention may be suitably practiced in the absence of any element not specifically disclosed herein.

All patents and patent applications cited above, including those in the Background section, are incorporated by reference into this document in total.

1. A device for sealing an end of a metering nip for metering a fluid material, where the metering nip comprises a first metering surface opposite a second metering surface, said device comprising:
a high pressure chamber comprising a cavity operatively adapted for being filled with a pressurized gas, and a sealing element that at least partially defines said high pressure cavity; and
a low pressure chamber comprising a cavity operatively adapted for being filled with a pressurized gas, and another sealing element that at least partially defines said low pressure cavity,
wherein the sealing element of each said pressure chamber has a first sealing surface and a second sealing surface, each said first sealing surface is resilient and operatively adapted so as to be forced into contact and form a seal with the first metering surface of the metering nip, each said second sealing surface is resilient and operatively adapted so as to be forced into contact and form a seal with the second metering surface of the metering nip, said low pressure chamber is disposed relative to said high pressure chamber such that the sealing element of said low pressure chamber will be in contact with the fluid material metered by the metering nip, the cavity of said high pressure chamber is operatively adapted to be filled with a gas at a pressure that will prevent a substantial amount of the fluid material to be metered from leaking out past the sealing element of said high pressure chamber, and the pressurized gas to be used in said low pressure chamber is to be at a pressure that will not force a substantial amount of the pressurized gas into the fluid material to be metered.

2. The device according to claim 1, wherein each said sealing element comprises two separate and spaced apart resilient seals.

3. The device according to claim 2, wherein each said chamber shares one of said resilient seals.

4. The device according to claim 1, wherein each of said resilient seals is in the form of a plate.

5. The device according to claim 1, wherein each said pressure chamber comprises a rigid element, and each said cavity is at least partially defined by one said rigid element.

6-8. (canceled)

9. The device according to claim 1, further comprising a separate source of pressurized gas for each said pressure chamber.

10. A coater for forming a layer of fluid material, said coater comprising:
a metering nip for metering a fluid material into a layer, said metering nip comprising two ends, and a first metering surface opposite a second metering surface; and
a device according to claim 1 mounted so as to seal one end of said metering nip.

11. (canceled)

12. The coater according to claim 10, further comprising a second of said device mounted so as to seal the other end of said metering nip.

13. The coater according to 10, wherein at least one said metering surface is a moving endless surface.

14. (canceled)

15. The coater according to claim 10, wherein each said metering surface is the radial surface of a nip roller.

16. The coater according to claim 10, wherein one said metering surface is a surface of a web of finite length moving through said metering nip, said coater further comprises a moving endless surface or a stationary surface backing said web, and the fluid material forms a coating on said web.

17. The coater according to claim 10, wherein said first metering surface and said second metering surface are oriented such that the fluid material passes vertically through said metering nip.

18. A method of forming a layer of fluid material, said method comprising:
providing a metering nip comprising a first metering surface opposite a second metering surface and opposite ends;
sealing at least one opposite end of the metering nip with the device according to claim 1 so as to form a metering reservoir;
disposing a fluid material within the metering reservoir; and
metering the fluid material into a layer.

19. (canceled)

20. The method according to claim 18, wherein said sealing further comprises:
forcing the first sealing surface and the second sealing surface, of the pressure chambers of each sealing device, respectively against the first metering surface and the second metering surface so as to make contact therebetween and seal the corresponding opposite end of the metering nip.

21. (canceled)

22. The method according to claim 18, further comprising:
filling the cavity of the high pressure chamber with a gas at a first pressure; and
filling the cavity of low pressure chamber with a gas at a second pressure,
wherein the first pressure prevents a substantial amount of the fluid material from leaking out past the sealing element of the high pressure chamber during said metering, and the second pressure does not force a substantial amount of the pressurized gas into the fluid material in the metering reservoir during said metering.

23. The method according to claim 22, wherein the first pressure prevents a commercially significant amount the fluid material from leaking out past the sealing element of the high pressure chamber, and the second pressure does not force an amount of the pressurized gas into the fluid material that would cause an unacceptable number and size of gas bubbles to form in the fluid material being metered.

24. (canceled)

25. The method according to claim 18, wherein each of the metering surfaces is a moving endless surface.

26. The method according to claim 18, wherein the first metering surface is a moving endless surface, and the second metering surface is a stationary surface.

27. (canceled)

28. The method according to claim 18, further comprises:
providing a web of finite length having a web surface that forms the first metering surface; and
backing the web with a moving endless surface or a stationary surface,
wherein the layer is a coating, and said metering further comprises:
moving the web through the metering nip so that the web surface is coated with the fluid material to form the coating,

29. The method according to claim 18, wherein said metering further comprises:
orienting the first metering surface and the second metering surface so as to vertically meter the fluid material through the metering nip to form the layer.
